(19) United States
(12) Patent Application Publication
(10) Pub. No.: US 2009/0172752 A1
(43) Pub. Date: Jul. 2, 2009

(54) STREAMING MULTIPLE VIDEOS IN A PLAYLIST

(75) Inventor: Thomas Lopatic, Berlin (DE)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/966,748

(22) Filed: Dec. 28, 2007

(51) Int. Cl. H04N 7/173

(52) U.S. Cl. 725/87

(57) ABSTRACT

In one embodiment, a play list corresponding to a client is retrieved, wherein the play list comprises a list of two or more videos, one of which is a video requested by the client. A compressed video stream is received from a first video source. The compressed video stream from the first video source is passed to the client without decompressing it. A compressed video stream is received from a second video source. Meta information of frames of the compressed video stream from the second video source is adapted. The passing the compressed video stream from the first video source is stopped. The adapted compressed video stream is then passed from the second video source to the client without decompressing it.

### BACKGROUND OF THE INVENTION

1. Field of the Invention

The present invention relates to video streaming. More particularly, the present invention relates to streaming multiple videos in a playlist.

2. Description of the Related Art

The distribution of videos over the Internet has become increasing popular the last several years. As bandwidth speeds have increased, it has become much easier for users to view video online in real time. Additionally, the popularity of viral video sites, where users are presented with a listing of similar videos when or after viewing a video, has brought a whole new audience to online videos. Further bolstering this increase in popularity has been the recently introduced ability to view online videos on cellular phones and personal data assistants.

Companies producing or distributing online videos are able to generate revenues by inserting advertising into the user's viewing experience. This may include placing ads alongside the window displaying the video, but may also include inserting advertising into the video stream itself. Pre-roll advertising is played prior to a video being played, while post-roll advertising is played after a video is played. Additionally, it is becoming increasingly common to insert interstitial or mid-video advertising breaks, much like commercials on broadcast television.

Distribution of videos online typically involves encoding frames in a video stream and numbering the individual frames so that they can be referenced.

### SUMMARY OF THE INVENTION

In one embodiment, a play list corresponding to a client is retrieved, wherein the play list comprises a list of two or more videos, one of which is a video requested by the client. A compressed video stream is received from a first video source. The compressed video stream from the first video source is passed to the client without decompressing it. A compressed video stream is received from a second video source. Meta information of frames of the compressed video stream from the second video source is adapted. The passing the compressed video stream from the first video source is stopped. The adapted compressed video stream is then passed from the second video source to the client without decompressing it.

### BRIEF DESCRIPTION OF THE DRAWINGS

FIG. 1 illustrates an example of inserting a video stream after another video stream in accordance with an embodiment of the present invention.

FIG. 2 illustrates an example of inserting a video stream in the middle of another video stream in accordance with an embodiment of the present invention.

FIG. 3 illustrates an example of inserting a video stream at the beginning of another video stream in accordance with an embodiment of the present invention.

FIGS. 4A-4C depict an example of flow control in accordance with an embodiment of the present invention.

FIG. 5 is a flow diagram illustrating a method in accordance with an embodiment of the present invention.

FIG. 6 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In a desktop environment, a list of video stream uniform resource locators (URLs) may be received by the desktop, Each URL may link to a video stream, and thus the list may include URLs to content the user requested (e.g., the video the user has selected), as well to content the user has not requested (e.g., commercials). The desktop video player may play these streams sequentially, so that the rendition appears like a single stream to the user. Therefore, such a playlist could start with, for example, the URL of a pre-roll advertising stream, followed by the URL of a first part of the requested content, followed by a URL of another advertising stream for a commercial break, followed by the URL of a third part of the content stream, followed by a URL for a post-roll advertising stream URL.

While this may work well for desktop computers, mobile devices typically lack proper play list support. These devices can accept a URL and render a single video stream identified by the URL, but lack the processing capability and/or bandwidth to operate a play list of more than one URL.

In an embodiment of the present invention, the play list is moved from the client to a proxy server. A mobile device may be pointed to a single URL, namely a URL of a stream on this proxy server, rather than passing a play list to the client. The stream of the proxy server is assembled on the fly from the source streams in the play list that resides on the proxy. The proxy would, for example, first stream the pre-roll advertising from somewhere on the Internet and then stream it to the client. It may then stream the first part of the video content from somewhere else on the Internet and stream it to the client. The proxy server works its way through the complete play list and streams all streams to it. While doing so, the proxy makes sure that the client does not notice that it is actually seeing different streams. In this embodiment, the client receives what appears to be a single continuous stream.

One way to accomplish this is for the proxy server to decompress all involved video streams, concatenate them, and re-compress the resulting combination into a single stream. However, compression can be expensive in terms of processing power. Therefore, in one embodiment of the present invention, individual video frames are left compressed and meta information of the frame, such as the frame numbers, are modified. The meta information may be altered on not just successive video (which would involve, for example, modifying frame numbers), but may also be altered on the initial video played as well (which may not, for example, involve modifying frame numbers but may involve modifying the source address of the frames or other identifying features such that the user believes the proxy server URL is the source of the video stream).

For example, suppose there are two source streams, each at 30 frames per second. The duration of the first stream is 10 second, so it has 300 frames. The duration of the second stream is 20 seconds, so it has 600 frames. The numbering of the frames in a stream typically starts at 0, so the frames of the first stream are numbered 0 through 299 and the frames of the second stream are numbered 0 through 599. In order to get contiguous frame numbers, stream #1 may be passed to the client without alteration. After the first stream has been fully received by the client, the client expects a frame with a frame number of 300. Therefore, an embodiment of the present invention renumbers the second stream frames 300 to 899. This may be performed without decompression and recompression and thus can operate very efficiently, i.e., the number of proxy servers required to handle a given number of streams is substantially lower.

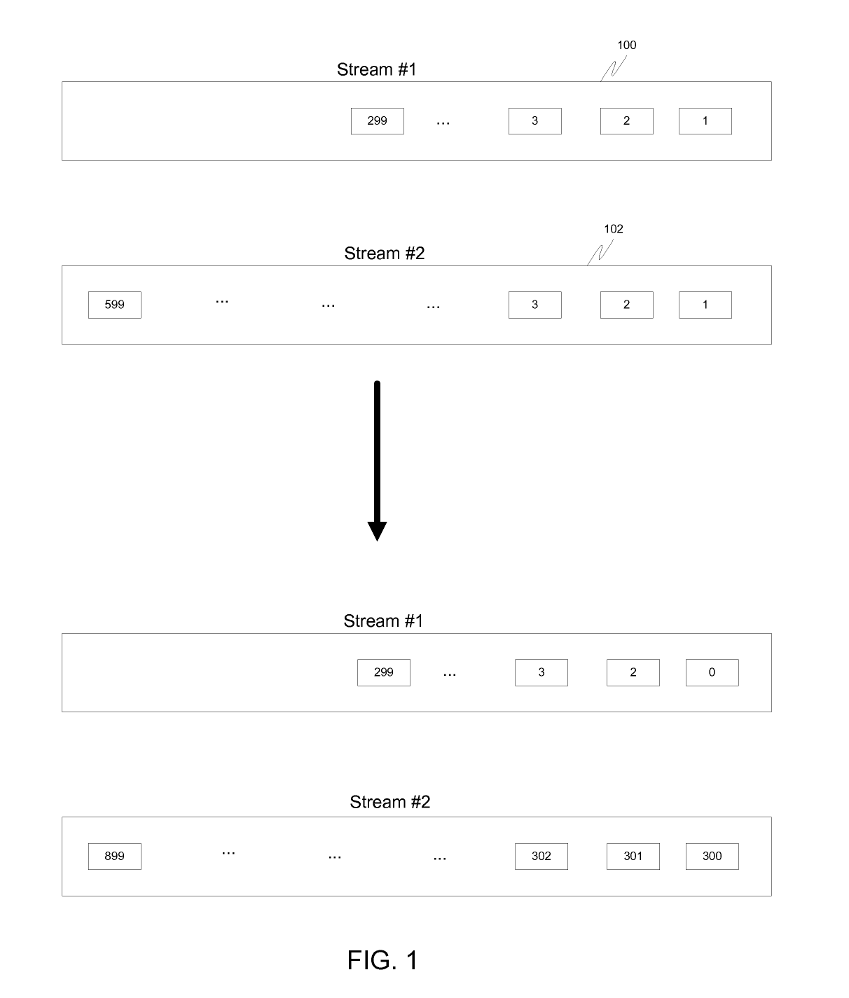

FIG. 1 illustrates an example of inserting a video stream after another video stream in accordance with an embodiment of the present invention. Here stream #1 100 contains frames 0-299 while stream #2 102 contains frames 0-599. If stream #2 is to be inserted after stream #1, frame numbers for stream #2 may be modified so that they begin at frame 300, as is shown at the bottom of the figure.

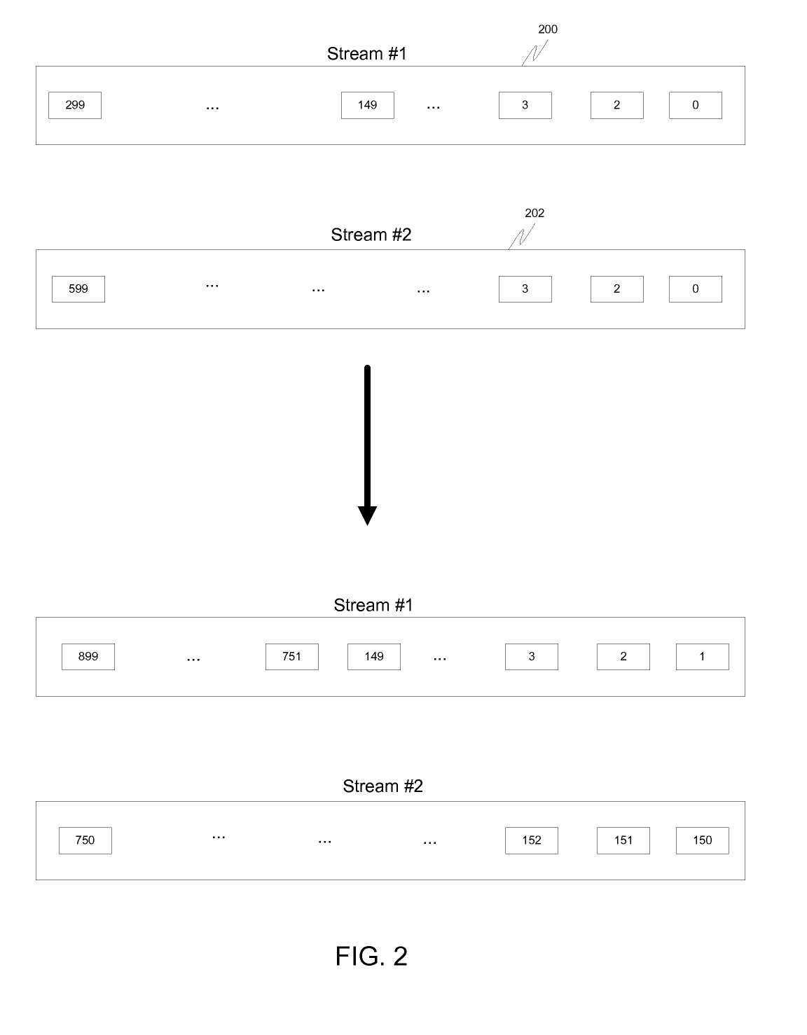

FIG. 2 illustrates an example of inserting a video stream in the middle of another video stream in accordance with an embodiment of the present invention. Here stream #1 200 contains frames 0-299 while stream #2 contains frames 0-599. If stream #2 is to be inserted after frame 149 of stream #1, then the frame numbers for stream #2 may be modified so they begin at frame 150, as is shown at the bottom of the figure. As is also shown at the bottom of the figure, original frame 150 and subsequent frames of stream #1 may be renumbered so the second part of stream #1 begins at frame 751.

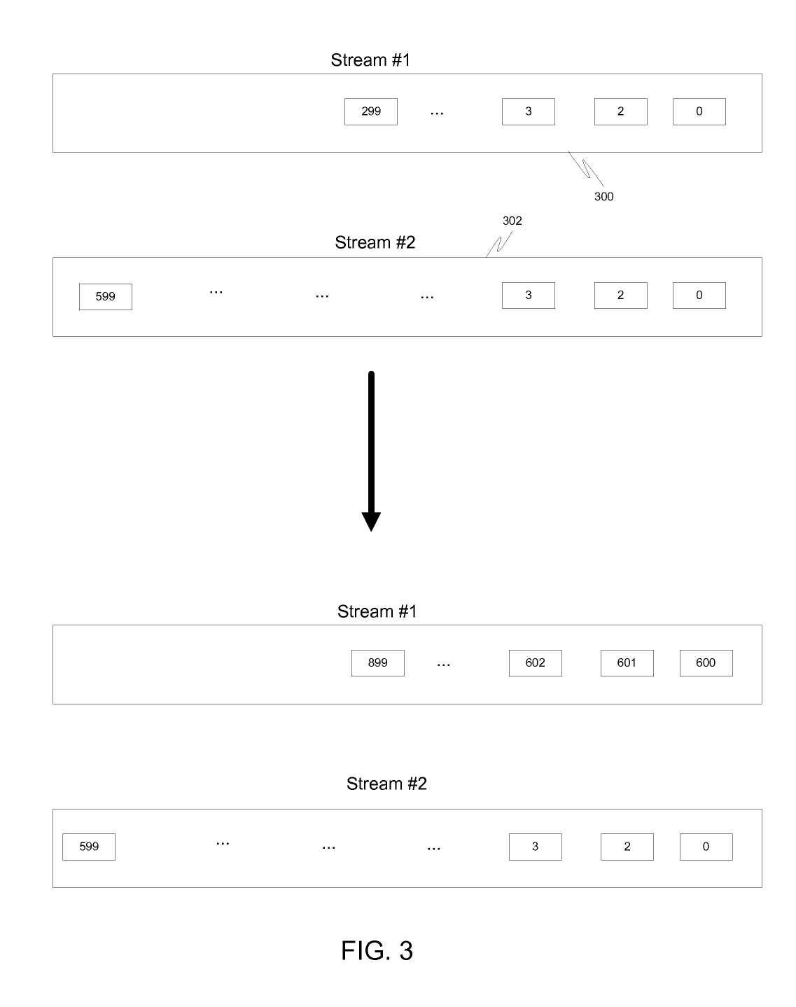

FIG. 3 illustrates an example of inserting a video stream at the beginning of another video stream in accordance with an embodiment of the present invention. Here stream #1 300 contains frames 0-299 while stream #2 302 contains frames 0-599. Frame number of stream #1 may be modified so that they begin at frame 600, as is shown at the bottom of the figure.

In another embodiment of the present invention, the ability to insert video streams into a playlist in real time is leveraged to permit the system to wait until the last possible moment to decide which advertisements to insert into a video stream. This enables a number of different advertising possibilities. Information regarding user preferences or other user attributes or behaviors can continue to be monitored up to the point in time when the advertisement is to be displayed. For example, the user may continue to search documents on the Internet as the video stream is being displayed on his screen. This information can be used to insert a commercial that is directly relevant to the topic the user is searching on at the moment. For example, the user may be watching a movie in a window on his display, and may be searching for home decorating ideas in a search engine while the movie runs. The system may utilize this information to insert a commercial relevant to home decorating, for example, a commercial for a cabinet company. This highly relevant commercial may not only be more targeted than a random commercial (and thus more valuable advertising to the cabinet company), it may also act to draw the user's attention back to the movie making it more likely he will pay attention to further commercials.

In another example, the current availability of a video stream may be used as a factor in the on-the-fly determination of whether or not to insert a particular video stream. For example, normal factors may indicate that the most desired advertising for the user would be a soda commercial. However, the proxy server may determine that the link to the source video server of the soda commercial may be inoperative or impaired. The proxy server may elect to insert an alternative, but similar, advertisement, such as a fruit juice commercial. This determination may also be based on how busy the link to the video source, or how busy the video source server itself, is. While a relatively busy link or server can still stream video, at least at the beginning, such a selection might have a higher likelihood of hanging or otherwise causing a delay during some part of the streaming of the commercial. As such, the proxy server may elect to avoid or disfavor such potentially-delaying video streams. Furthermore, certain users may gain preferential treatment with regard to such potentially-delaying video streams. For example, a user may elect to pay for a higher level of service to reduce transmission delays. Proxy servers directing video streams to such users may take this into account and may act to avoid potentially-delaying video streams on a case-by-case basis depending upon the service level of the user.

In another example, many cell phones now have the ability to detect the orientation in which the user is holding them. Since the orientation of the cell phone can be changed at a moments notice, the orientation of the user's cell phone right at the moment the video is ready to break for a commercial can be used to determine which commercial to play.

In another example, a mobile device's battery power level may be utilized to determine which commercial to play. For example, if the system determines that the mobile device is low on battery power, it may elect to show a shorter commercial. While such an action is unlikely to result directly in increased revenues to the advertiser or content provider, the user may be appreciative of a service that aids in the usability of his mobile device and thus may be more loyal to such a service and/or more likely to revisit the service in times when the mobile device is not low on power and normal-length commercials can be shown.

In an embodiment of the present invention, buffers are provided to enable flow control from the various input streams. This allows the proxy server to start or stop a stream. This flow control may be accomplished by first selecting a source video stream to become active. If there is already an active source video stream, the proxy server may signal the corresponding stream server to stop streaming. The stream's current state, S1, may be stored, and it may be marked as inactive. If the selected source video stream was active before, its own stored state, S2, may be loaded and the corresponding stream server may be signaled to start streaming. If the selected source video stream was not active before, its state S2 may be initialized and the corresponding stream server may be signaled to start streaming.

At this point, the selected source video stream may additionally be marked as active. Frames from the currently selected active video stream may be read. These frames may be adapted according to S1 and S2 if necessary. Frames may then be written to a target video stream (potentially with altered meta information) until the source video stream is to be switched again or ended.

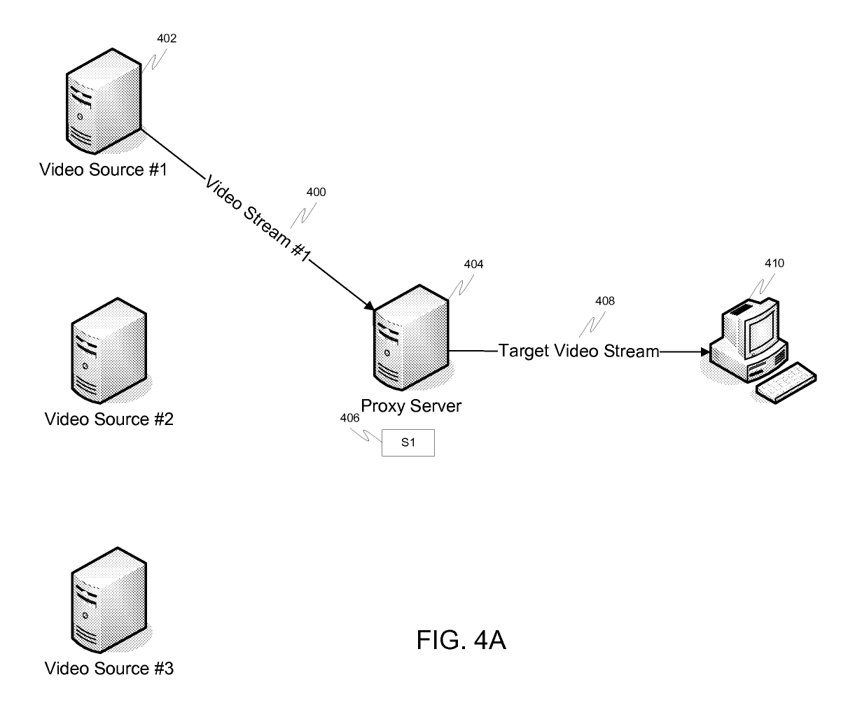

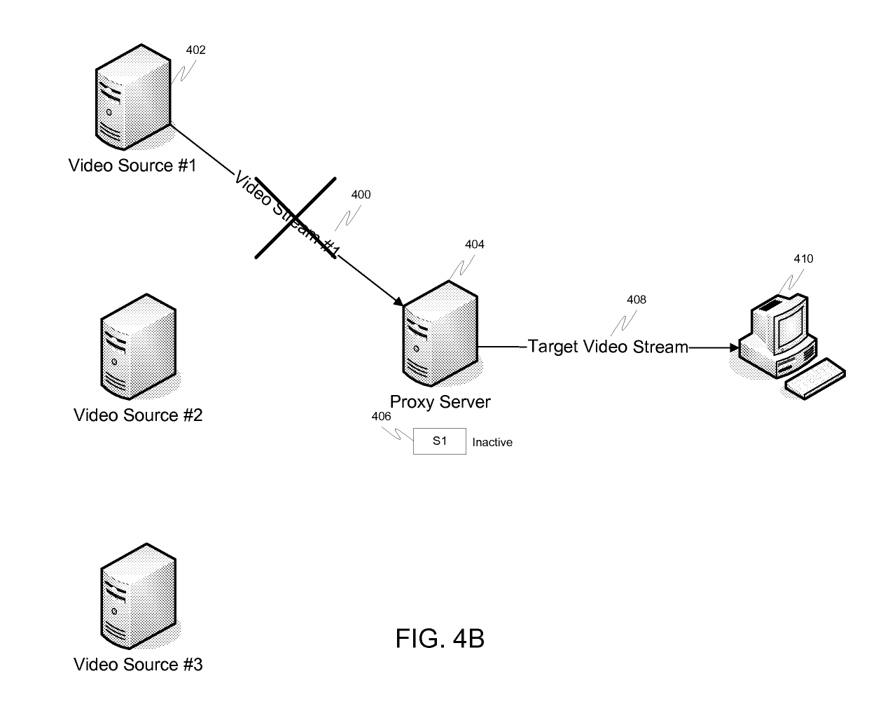

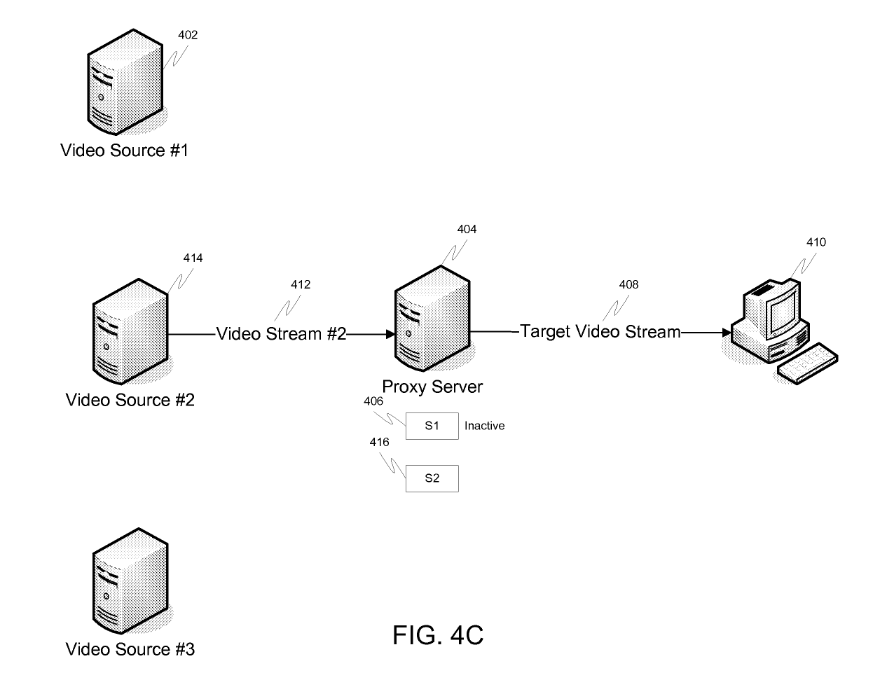

FIGS. 4A-4C depict an example of flow control in accordance with an embodiment of the present invention. Referring first to FIG. 4A, video stream #1 400 is being streamed from video source #1 402 to proxy server 404. Proxy server 404 stores state information S1 406 for video stream #1, including, for example, the current frame number that is being streamed. Proxy server 404 may pass video stream #1 un-decompressed into target video stream 408 being transmitted to client 410.

Referring to FIG. 4B, when proxy server determines that it is time to insert a new video into target video stream 408, video stream #1 400 may be stopped and the stored state information SI 406 may be labeled as inactive.

Referring to FIG. 4C, the proxy server may then request video stream #2 412 from video source #2 414, as well as initialize state information S2 416 for video stream #2 412. It may then pass video stream #2 412 un-decompressed into target video stream 408 being transmitted to client 410. Prior to doing this, however, it may alter meta information for video stream #2 412, such as the frame numbers, in accordance with state information S1 406 and S2 416.

In another embodiment of the present invention, the flow control steps outlined above may be partially overlapped in order to guarantee seamless streaming. For example, stopping the currently active source stream may be overlapped with receiving frames of the new selected source stream so that the currently active source stream is only stopped once frames from the new selected source stream are already being received. This may be further extended to include waiting to stop the currently active source stream until a sufficient number of frames from the new selected source stream have been received to fill a buffer or otherwise guarantee a seamless transition.

In another embodiment of the present invention, additional buffers are utilized to store frames from multiple video streams simultaneously, further ensuring that seamless streaming can be guaranteed to the user. This would also act to negate (either partially or completely) the inclusion of the availability or potential delay of a video stream as a factor in determining (on-the-fly) which video stream to select, as was described earlier.

In another embodiment of the present invention, some or all of the various steps described above with respect to the invention are extended to other devices than merely mobile devices. For example, embodiments are envisioned wherein the same techniques are applied to desktop devices. Despite the ability of most desktop systems to handle video streams from multiple sources, there may be various advantages to utilizing a proxy server anyway. Some of these advantages may include reduction of network bandwidth, ease of integration with a network or system having both mobile and non-mobile devices, preservation of processing power for other tasks, etc.

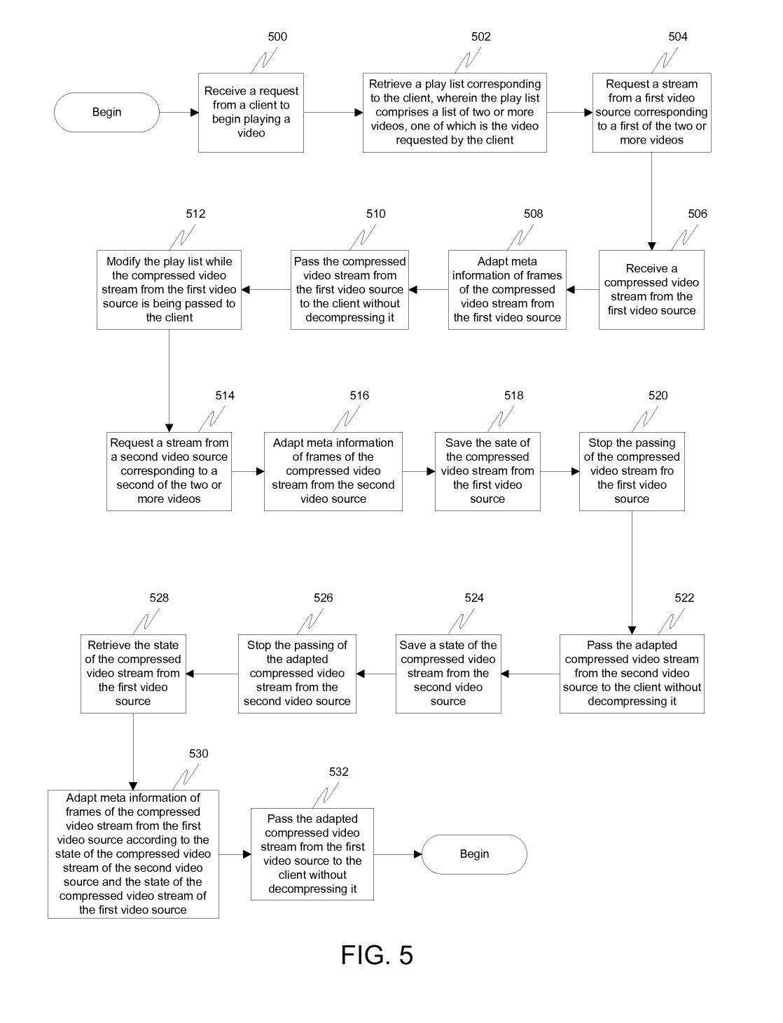

FIG. 5 is a flow diagram illustrating a method in accordance with an embodiment of the present invention. Each step of this method may be embodied in hardware, software, or any combination thereof. At 500, a request is received from a client to begin playing a video. At 502, a play list corresponding to the client is retrieved, wherein the play list comprises a list of two or more videos, one of which is the video requested by the client. At 504, a stream is requested from a first video source corresponding to a first of the two or more videos. At 506, a compressed video stream is received from the first video source. At 508, meta information of frames of the compressed video stream from the first video source may be adapted. This adapting may include, for example, modifying source information of the frames. At 510, the compressed video stream is passed from the first video source to the client without decompressing it.

At 512, the play list may be modified while the compressed video stream from the first video source is being passed to the client. This may include, for example, changing the second of the two or more videos on the list. At 514, a stream is requested from a second video source corresponding to a second of the two or more videos. At 516, a compressed video stream is received from the second video source. At 518, meta information of frames of the compressed video stream from the second video source is adapted. This adapting may include modifying frame numbers of frames of the compressed video stream from the second video source so that the frame numbers begin immediately after the final frame number played or to be played prior to the playing of the compressed video stream from the second video source, of the compressed video stream from the first video source. At 520, the state of the compressed video stream from the first video source may be saved. At 522, the passing of the compressed video stream from the first video source is stopped. At 524, the adapted compressed video stream from the second video source is passed to the client without decompressing it.

At 526, a state of the compressed video stream from the second video source may be saved. At 528, the passing of the adapted compressed video stream from the second video source may be stopped. At 530, the state of the compressed video stream from the first video source may be retrieved. At 532, meta information of frames of the compressed video stream from the first video source may be adapted according to the state of the compressed video stream of the second video source and the state of the compressed video stream of the first video source. At 534, the adapted compressed video stream from the first video source may be passed to the client without decompressing it.

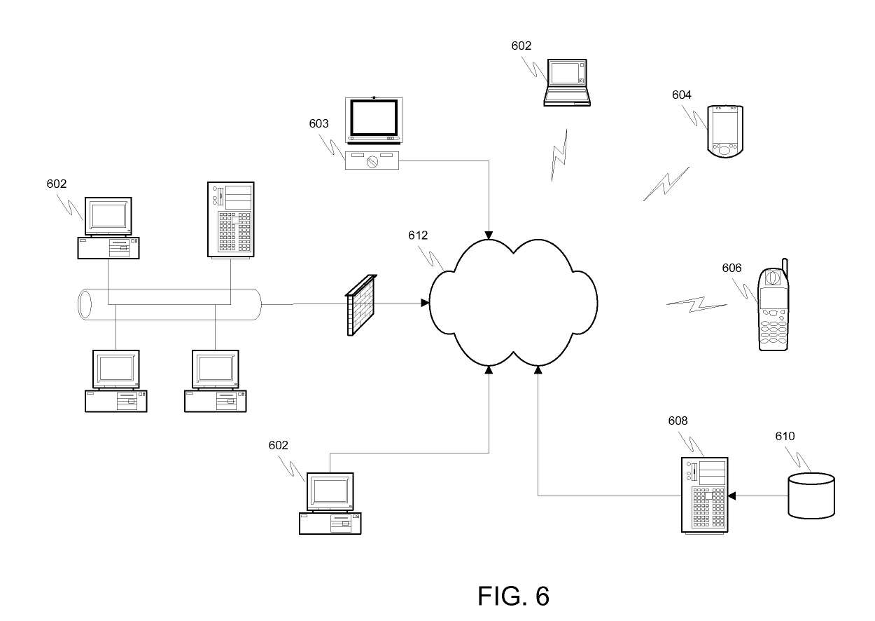

It should also be noted that embodiments of the present invention may be implemented on any computing platform and in any network topology in which presentation of service results is a useful functionality. For example and as illustrated in FIG. 6, implementations are contemplated in which the invention is implemented in a network containing personal computers 602, media computing platforms 603 (e.g., cable and satellite set top boxes with navigation and recording capabilities (e.g., Tivo)), handheld computing devices (e.g., PDAs) 604, cell phones 606, or any other type of portable communication platform. Users of these devices may navigate the network and request from a proxy server that a video be streamed. A user may utilize a mobile device such as 604 and 606 to perform client-side macros and/or to request that a server run server-side macros. Proxy Server 608 (or any of a variety of computing platforms) may include a memory, a processor, and a communications component and may then utilize the various techniques described above. The processor of the proxy server 608 may be configured to run, for example, all of the processes described in FIG. 5. Server 608 may be coupled to a database 610, which stores information relating to the state information of video streams. Applications may be resident on such devices, e.g., as part of a browser or other application, or be served up from a remote site, e.g., in a Web page. The invention may also be practiced in a wide variety of network environments (represented by network 612), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
receiving a request from a client to begin playing a video;
retrieving a play list corresponding to the client, wherein the play list comprises a list of two or more videos, one of which is the video requested by the client;
requesting a stream from a first video source corresponding to a first of the two or more videos;
receiving a compressed video stream from the first video source;
passing the compressed video stream from the first video source to the client without decompressing it;
requesting a stream from a second video source corresponding to a second of the two or more videos;
receiving a compressed video stream from the second video source;
adapting meta information of frames of the compressed video stream from the second video source;
stopping passing the compressed video stream from the first video source; and
passing the adapted compressed video stream from the second video source to the client without decompressing it.

2. The method of claim 1, wherein the video requested by the client is from either the first video source or the second video source.

3. The method of claim 1, wherein the adapting includes modifying frame numbers of frames of the compressed video stream from the second video source so that the frame numbers begin immediately after the final frame number played or to be played prior to the playing of the compressed video stream from the second video source, of the compressed video stream from the first video source.

4. The method of claim 1, further comprising modifying the play list while the compressed video stream from the first video source is being passed to the client.

5. The method of claim 4, wherein the modifying includes changing the second of the two or more videos.

6. The method of claim 1, further comprising saving a state of the compressed video stream from the first video source prior to stopping passing the compressed video stream from the first video source.

7. The method of claim 6, further comprising:
saving a state of the compressed video stream from the second video source;
stopping passing the adapted compressed video stream from the second video source;
retrieving the state of the compressed video stream from the first video source;
resuming reception of the compressed video stream from the first video source;
adapting meta information of frames of the compressed video stream from the first video source according to the state of the compressed video stream of the second video source and the state of the compressed video stream of the first video source; and
passing the adapted compressed video stream from the first video source to the client without decompressing it.

8. A proxy server comprising:
one or more buffers configured to store video streams;
one or more processors configured to perform the following steps:
receiving a request from a client to begin playing a video;
retrieving a play list corresponding to the client, wherein the play list comprises a list of two or more videos, one of which is the video requested by the client;
requesting a stream from a first video source corresponding to a first of the two or more videos;
receiving a compressed video stream from the first video source;
passing the compressed video stream from the first video source to the client without decompressing it;
requesting a stream from a second video source corresponding to a second of the two or more videos;
receiving a compressed video stream from the second video source;
adapting meta information of frames of the compressed video stream from the second video source;
stopping passing the compressed video stream from the first video source; and
passing the adapted compressed video stream from the second video source to the client without decompressing it.

9. The proxy server of claim 8, wherein the video requested by the client is from either the first video source or the second video source.

10. The proxy server of claim 8, wherein the adapting includes modifying frame numbers of frames of the compressed video stream from the second video source so that the frame numbers begin immediately after the final frame number played or to be played prior to the playing of the compressed video stream from the second video source, of the compressed video stream from the first video source.

11. The proxy server of claim 8, wherein the one or more processors are further configured to perform modifying the play list while the compressed video stream from the first video source is being passed to the client.

12. The proxy server of claim 11, wherein the modifying includes changing the second of the two or more videos.

13. The proxy server of claim 8, wherein the one or more processors are further configured to perform saving a state of the compressed video stream from the first video source prior to stopping passing the compressed video stream from the first video source.

14. The proxy server of claim 13, wherein the one or more processors are further configured to perform the following steps:
saving a state of the compressed video stream from the second video source;
stopping passing the adapted compressed video stream from the second video source;
retrieving the state of the compressed video stream from the first video source;
resuming reception of the compressed video stream from the first video source;
adapting meta information of frames of the compressed video stream from the first video source according to the state of the compressed video stream of the second video source and the state of the compressed video stream of the first video source; and passing the adapted compressed video stream from the first video source to the client without decompressing it.

15. An apparatus comprising:
means for receiving a request from a client to begin playing a video;
means for retrieving a play list corresponding to the client, wherein the play list comprises a list of two or more videos, one of which is the video requested by the client;
means for requesting a stream from a first video source corresponding to a first of the two or more videos;
means for receiving a compressed video stream from the first video source;
means for passing the compressed video stream from the first video source to the client without decompressing it;
means for requesting a stream from a second video source corresponding to a second of the two or more videos;
means for receiving a compressed video stream from the second video source;
means for adapting meta information of frames of the compressed video stream from the second video source;
means for stopping passing the compressed video stream from the first video source; and
means for passing the adapted compressed video stream from the second video source to the client without decompressing it.

16. The apparatus of claim 15, wherein the video requested by the client is from either the first video source or the second video source.

17. The apparatus of claim 15, wherein the means for adapting includes means for modifying frame numbers of frames of the compressed video stream from the second video source so that the frame numbers begin immediately after the final frame number played or to be played prior to the playing of the compressed video stream from the second video source, of the compressed video stream from the first video source.

18. The apparatus of claim 15, further comprising means for modifying the play list while the compressed video stream from the first video source is being passed to the client.

19. The apparatus of claim 18 wherein the means for modifying includes means for changing the second of the two or more videos.

20. The apparatus of claim 15, further comprising means for saving a state of the compressed video stream from the first video source prior to stopping passing the compressed video stream from the first video source.

21. The apparatus of claim 20, further comprising:
means for saving a state of the compressed video stream from the second video source;
means for stopping passing the adapted compressed video stream from the second video source;
means for retrieving the state of the compressed video stream from the first video source;
means for resuming reception of the compressed video stream from the first video source;
means for adapting meta information of frames of the compressed video stream from the first video source according to the state of the compressed video stream of the second video source and the state of the compressed video stream of the first video source; and
means for passing the adapted compressed video stream from the first video source to the client without decompressing it.

22. A program storage device readable by a machine tangibly embodying a program of instructions executable by the machine to perform a method comprising:
receiving a request from a client to begin playing a video;
retrieving a play list corresponding to the client, wherein the play list comprises a list of two or more videos, one of which is the video requested by the client;
requesting a stream from a first video source corresponding to a first of the two or more videos;
receiving a compressed video stream from the first video source;
passing the compressed video stream from the first video source to the client without decompressing it;
requesting a stream from a second video source corresponding to a second of the two or more videos;
receiving a compressed video stream from the second video source;
adapting meta information of frames of the compressed video stream from the second video source;
stopping passing the compressed video stream from the first video source; and
passing the adapted compressed video stream from the second video source to the client without decompressing it.
